(19) United States
(12) Patent Application Publication
(10) Pub. No.: US 2026/0274210 A1
(43) Pub. Date: Sep. 17, 2026

(54) Multifunctional vehicle-mounted device

(71) Applicant: Chunhui Lin, Huazhou (CN)

(72) Inventor: Chunhui Lin, Huazhou (CN)

(21) Appl. No.: 19/672,601

(22) Filed: May 9, 2026

(30) Foreign Application Priority Data
Mar. 5, 2026 (CN) 202620266530.9

(51) Int. Cl. B60S 1/64; B60C 23/10

(52) U.S. Cl. CPC B60S 1/64; B60C 23/10

(57) ABSTRACT

A multifunctional vehicle-mounted device, including: a housing mounted with a main control board, a power supply, a blowing and vacuuming assembly and an inflation assembly. The power supply, the blowing and vacuuming assembly and the inflation assembly are each electrically connected to the main control board. The power supply is configured to start in an emergency state and supply power to the blowing and vacuuming assembly and the inflation assembly, the blowing and vacuuming assembly is configured to generate positive-pressure airflow and negative-pressure airflow, and the inflation assembly is configured to inflate vehicle tires.

### CROSS-REFERENCE TO RELATED APPLICATIONS

This application claims priority to Chinese Patent Application No. 202620266530.9, filed on Mar. 5, 2026 in the China National Intellectual Property Administration, the entire disclosure of which is hereby incorporated by reference.

### TECHNICAL FIELD

The present disclosure relates to the technical field of vehicle-mounted device, in particular to a multifunctional vehicle-mounted device.

### BACKGROUND

With the continuous increase in automobile ownership, vehicle owners have put forward higher requirements for the functionality, convenience, and degree of integration of vehicle-mounted auxiliary equipment. In the course of daily vehicle use, vehicles may encounter various sudden or routine maintenance needs, such as battery power depletion, tire air leakage, dust accumulation inside the vehicle, and power failure of electronic equipment. In order to address the above problems, various vehicle-mounted portable devices have appeared on the market, mainly including automobile emergency starting power supplies, tire inflators, vehicle-mounted vacuum cleaners, and portable blowing/dust-removing devices.

However, existing products generally suffer from the limitations of “single-function design” or “weak integration design.” On the one hand, most devices possess only a single function-for example, they support only emergency starting or are used solely for inflation-requiring users to purchase and carry multiple separate devices simultaneously, which not only occupies limited interior vehicle space but also increases the complexity of use and management. On the other hand, although some products attempt to integrate several electronic functions (such as mobile power supplies, universal serial bus (USB) charging, etc.), the scope of such integration is usually limited to low-power electronic modules and fails to effectively incorporate functional modules involving mechanical transmission and pneumatic systems (such as inflation, dust suction, and blowing), resulting in continued reliance on multiple independent devices when facing composite vehicle-use scenarios.

In addition, even though a few products claim to possess multiple functions, their structural designs often lack systematic optimization: the layout of the functional modules is unreasonable, switching operations are cumbersome, shared components (such as motors, air paths, and power supply systems) are not efficiently reused, and cleaning and maintenance are difficult, seriously affecting user experience and device reliability. For example, when inflation and dust suction functions are simultaneously integrated in the same device, if an integrated design is not adopted for the airflow path, valve control, and motor steering, functional conflicts, low efficiency, or even device damage may occur.

### SUMMARY

The present disclosure provides a compact, structurally integrated, functionally synergistic, user-friendly and maintenance-convenient multifunctional vehicle-mounted device, aims to integrate a plurality of high-frequency practical functions, including emergency power starting, tire inflation, in-vehicle vacuum cleaning, and directional air blowing, within a single unified physical platform.

To realize the above objective, the present disclosure provides a multifunctional vehicle-mounted device, including: a housing mounted with a main control board, a power supply, a blowing and vacuuming assembly and an inflation assembly; the power supply, the blowing and vacuuming assembly and the inflation assembly are each electrically connected to the main control board; and the power supply is configured to start in an emergency state and supply power to the blowing and vacuuming assembly and the inflation assembly, the blowing and vacuuming assembly is configured to generate positive-pressure airflow and negative-pressure airflow, and the inflation assembly is configured to inflate vehicle tires.

Preferably, the power supply comprises a battery pack, a charging interface and a discharge interface; the battery pack, the charging interface and the discharge interface are each electrically connected to the main control board; and the battery pack is installed inside the housing; and the charging interface and the discharge interface are disposed on a side portion of the housing and exposed outwardly.

Preferably, the charging interface and the discharge interface are each provided with a dust-proof silicone plug.

Preferably, the blowing and vacuuming assembly comprises a motor, an air outlet adapter, a vacuuming adapter, a filter component and a garbage storage chamber; the motor is mounted inside the housing by a motor connecting piece, the air outlet adapter and the vacuuming adapter are respectively disposed on opposite sides of the housing and are in fluid communication with air-duct ends of the motor; and the garbage storage chamber is connected to one end of the vacuuming adapter away from the housing, and the filter component is located between the vacuuming adapter and the garbage storage chamber.

Preferably, an end of the garbage storage chamber away from the housing is provided with a suction nozzle, and the suction nozzle is provided with a leak-proof silicone plug.

Preferably, the inflation assembly comprises an inflation pump motor and an inflation pipeline, the inflation pump motor is mounted inside the housing, one end of the inflation pipeline communicates with the inflation pump motor, and the other end extends out of the housing.

Preferably, the multifunctional vehicle-mounted device further comprises a lighting assembly; the lighting assembly comprises a light cover and a light-emitting diode (LED) light panel electrically connected to the main control board; and the light cover is located on an outer side of the LED light panel and connected to the housing.

Preferably, the main control board is further integrated with a digital display.

Preferably, the housing further comprises a surface sticker disposed on an outer side of the housing in a region corresponding to the digital display.

Preferably, the main control board is further integrated with an indicator light.

Compared with the prior art, the multifunctional vehicle-mounted device of the present disclosure has the following beneficial effects: by integrating a power supply, a blowing and vacuuming assembly, and an inflation assembly into the same housing, and by unified coordinated control through a main control board, structured and systematic integration of multiple high-frequency vehicle-mounted emergency and maintenance functions is achieved, thereby improving the practicality, portability, and user experience of the multifunctional vehicle-mounted device.

The present disclosure will be further described below with reference to the accompanying drawings and specific embodiments.

### BRIEF DESCRIPTION OF DRAWINGS

In order to more clearly illustrate the technical solutions in the embodiments of the present disclosure, the drawings required for use in the description of the embodiments or the prior art will be briefly introduced below. Obviously, the drawings described below are merely some embodiments of the present disclosure. For those of ordinary skill in the art, other drawings can also be obtained according to these drawings without creative effort.

FIG. 1 is a schematic structural diagram of a multifunctional vehicle-mounted device provided by the present disclosure.

FIG. 2 is an exploded schematic view of the multifunctional vehicle-mounted device provided by the present disclosure.

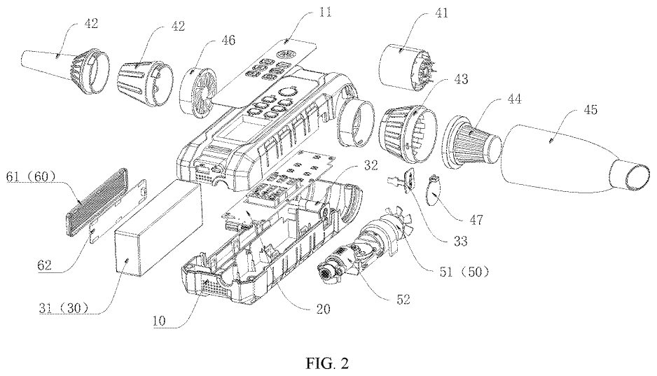

FIG. 3 is a schematic structural diagram of the multifunctional vehicle-mounted device, in which the assemblies are mounted in compartments of the housing.

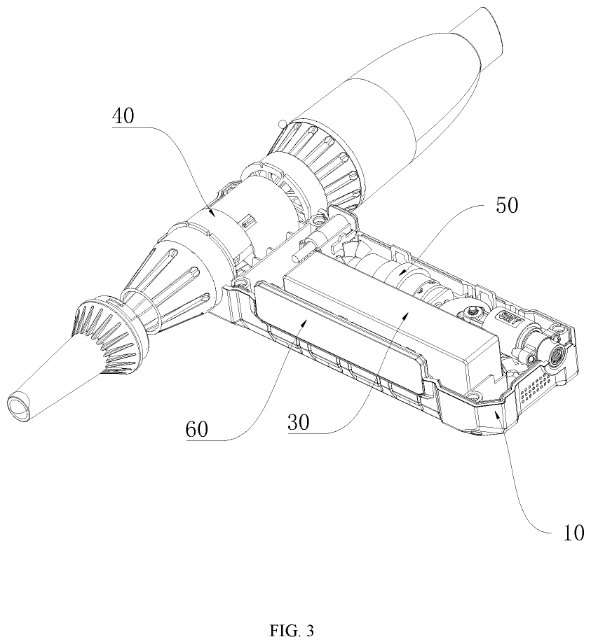

FIG. 4 is a schematic structural diagram of a main control board of the multifunctional vehicle-mounted device.

FIG. 5 is a schematic structural diagram of a power supply of the multifunctional vehicle-mounted device.

FIG. 6 is a schematic structural diagram of a blowing and vacuuming assembly of the multifunctional vehicle-mounted device.

FIG. 7 is a schematic structural diagram of a inflation assembly of the multifunctional vehicle-mounted device.

FIG. 8 is a schematic structural diagram of a lighting assembly of the multifunctional vehicle-mounted device.

FIG. 9 is a schematic structural diagram of a housing of the multifunctional vehicle-mounted device

FIG. 10 is a schematic structural diagram of the multifunctional vehicle-mounted device, viewed from another angle.

### DESCRIPTION OF THE REFERENCE NUMERALS

10 housing, 11 surface sticker, 002 main control board compartment, 003 power supply compartment, 004 blowing and vacuuming assembly compartment, 005 inflation assembly compartment, 006 lighting assembly compartment, 20 main control board, 21 digital display, 22 indicator light, 30 power supply, 31 battery pack, 32 discharge interface, 33 dust-proof silicone plug, 34 charging interface, 40 blowing and vacuuming assembly, 41 high-speed motor, 42 air outlet adapter, 43 vacuuming adapter, 44 filter component, 45 garbage storage chamber, 46 motor connecting piece, 47 leak-proof silicone plug, 48 suction nozzle, 50 inflation assembly, 51 inflation pump motor, 52 inflation pipeline, 60 lighting assembly, 61 light cover, 62 LED light panel.

### DETAILED DESCRIPTION OF THE EMBODIMENTS

In order to make the objectives, technical solutions, and advantages of the present disclosure clearer, the present disclosure will be further described in detail below with reference to the accompanying drawings and specific embodiments.

The technical solutions in the embodiments of the present disclosure will be clearly and completely described below with reference to the accompanying drawings in the embodiments of the present disclosure. Obviously, the described embodiments are only some embodiments of the present disclosure, rather than all embodiments. Based on the embodiments of the present disclosure, all other embodiments obtained by those skilled in the art without creative effort shall fall within the protection scope of the present disclosure.

In the description of the present disclosure, it should be understood that the terms “center,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” and the like indicate orientations or positional relationships based on the orientations or positional relationships shown in the drawings, and are merely for the convenience of describing the present disclosure and simplifying the description, rather than indicating or implying that the multifunctional vehicle-mounted device or element referred to must have a specific orientation, be constructed and operated in a specific orientation, and therefore cannot be construed as a limitation on the present disclosure.

In addition, the terms “first” and “second” are used for descriptive purposes only and cannot be understood as indicating or implying relative importance or implicitly indicating the number of technical features indicated. Thus, a feature defined as “first” or “second” may explicitly or implicitly include one or more of those features. In the description of the present disclosure, “plurality” means two or more, unless otherwise expressly and specifically defined.

In the present disclosure, unless otherwise expressly specified and defined, the terms “mounted,” “connected,” “linked,” “fixed,” and the like should be understood in a broad sense; for example, they may be a fixed connection, a detachable connection, or an integral connection; they may be a mechanical connection or an electrical connection; they may be a direct connection or an indirect connection through an intermediate medium; they may be internal communication between two elements or an interaction relationship between two elements. For those of ordinary skill in the art, the specific meanings of the above terms in the present disclosure can be understood according to specific circumstances.

In the present disclosure, unless otherwise expressly specified and defined, when a first feature is described as being “on” or “under” a second feature, it may include direct contact between the first and second features, or it may include the first and second features not being in direct contact but being in contact through another feature between them. Moreover, when a first feature is described as being “above,” “over,” or “on” a second feature, it includes the first feature being directly above and obliquely above the second feature, or it merely indicates that the first feature is horizontally higher than the second feature. When a first feature is described as being “below,” “under,” or “beneath” a second feature, it includes the first feature being directly below and obliquely below the second feature, or it merely indicates that the first feature is horizontally lower than the second feature.

In the description of this specification, descriptions with reference to the terms “one embodiment,” “some embodiments,” “example,” “specific example,” or “some examples” mean that specific features, structures, materials, or characteristics described in connection with the embodiment or example are included in at least one embodiment or example of the present disclosure. In this specification, schematic representations of the above terms should not be construed as necessarily referring to the same embodiment or example. Moreover, the specific features, structures, materials, or characteristics described may be combined in any suitable manner in any one or more embodiments or examples. In addition, those skilled in the art may combine and integrate different embodiments or examples described in this specification.

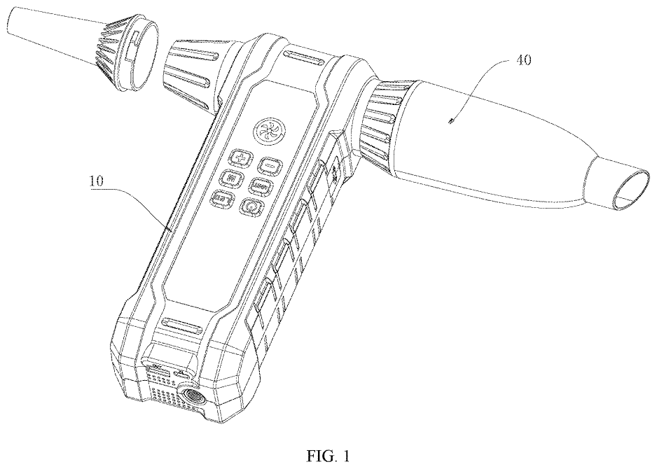

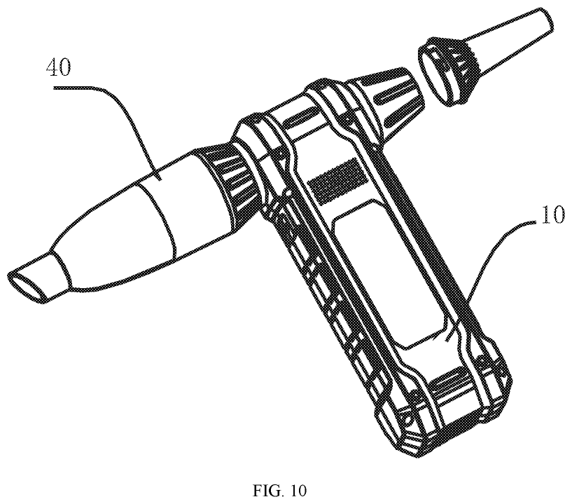

Referring to the FIGS. 1 and 10, an embodiment of the present disclosure discloses a multifunctional vehicle-mounted device, including: a housing 10 mounted with a main control board 20, a power supply 30, a blowing and vacuuming assembly 40, an inflation assembly 50, and the lighting assembly 60. The power supply 30, the blowing and vacuuming assembly 40, and the inflation assembly 50 are each electrically connected to the main control board 20. The power supply 30 is configured to start in an emergency state and supply power to the multifunctional vehicle-mounted device. The blowing and vacuuming assembly 40 is configured to generate positive-pressure airflow and negative-pressure airflow. The inflation assembly 50 is configured to inflate vehicle tires.

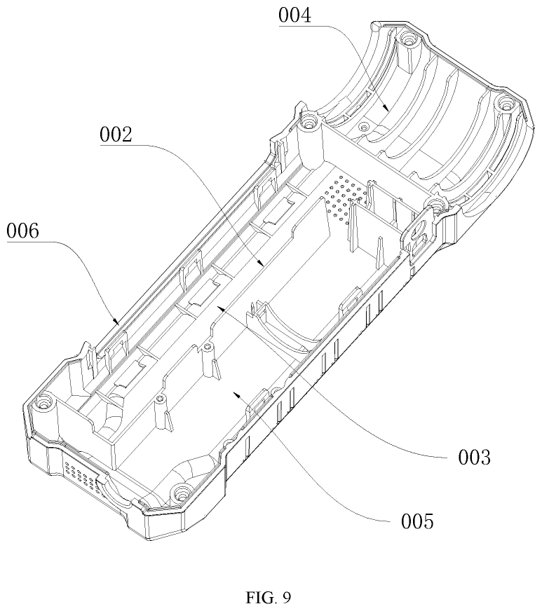

As shown in FIG. 9, the housing 10 is an outer shell made of a compact, high-strength engineering plastic or metal composite material, the outer shape of which is ergonomically designed to facilitate handheld use or vehicle-mounted fixation. The interior of the housing 10 is provided with a plurality of functional compartments: a main control board compartment 002, a power supply compartment 003, a blowing and a vacuuming assembly compartment 004, a inflation assembly compartment 005, and a lighting assembly compartment 006. Each compartment for partitioned mounting of the assemblies, main control board compartment 002 is mounted with the main control board 20, the power supply compartment 003 is mounted with the power supply 30, blowing and a vacuuming assembly compartment 004 is mounted with the blowing and vacuuming assembly 40, the inflation assembly compartment 005 is mounted with the inflation assembly 50, and the lighting assembly compartment 006 is mounted with the lighting assembly 60. The main control board 20 is arranged above the power supply 30 and the inflation assembly 50. Further, physical partitions or damping structures are arranged between the respective assemblies to isolate vibration, electromagnetic noise, heat conduction, and the like. A functional interface area may be provided on the surface of the housing 10, including: a vehicle starting clamp (connected to an automobile battery), an inflation nozzle interface, a vacuuming/blowing port, power output ports, status indicator lights, operation buttons, and the like. The power output ports include universal serial bus type-A (USB-A), and universal serial bus type-C (USB-C).

The main control board 20 integrates a microcontroller (MCU), a power management unit (PMU), a motor drive circuit, a sensor interface, and human-machine interaction logic. Through software algorithms, the main control board 20 intelligently schedules the operating states of the respective modules, for example, by detecting the current operating mode (starting, inflation, vacuuming, or blowing), automatically switching power supply paths, controlling motor rotation direction, regulating output power, and providing over-current, over-voltage, over-temperature, and short-circuit protection functions. A user may select a functional mode through physical buttons or knobs arranged on the housing 10. The main control board 20 responds in real time and drives the corresponding assembly to operate.

The power supply 30 may include a high-rate lithium polymer battery pack (for example, with a capacity of 12 V/20 Ah or above), a battery protection board, and a boost/buck voltage regulation circuit. On the one hand, the power supply 30 connects to the positive and negative poles of a vehicle battery through a dedicated starting cable. When the vehicle battery is low, the power supply 30 provides an instantaneous large current (up to 600 A or above) to start the engine. On the other hand, as a common energy platform for the entire multifunctional vehicle-mounted device, the power supply 30 supplies a stable operating voltage (such as 12 V or 24 V) to the blowing and vacuuming assembly 40 and the inflation assembly 50 through a direct current to direct current (DC-DC) converter without requiring any additional external power source.

The blowing and vacuuming assembly 40 may include a high-speed brushless DC motor, a centrifugal or axial-flow impeller, a bidirectional airflow channel, and a switchable air nozzle. The motor is driven by the main control board 20. By changing the motor rotation direction, cooperating with an internal flow guide valve, a commutating baffle, or using a mechanical switching mechanism, the airflow direction is switched. During forward rotation, negative-pressure airflow is formed so that dust is sucked in from a suction inlet and collected through a dust collection bag or filter screen thereby realizing the vacuuming function. During reverse rotation, positive-pressure airflow is generated and ejected at high speed from an air outlet for blowing off accumulated dust in keyboard gaps, air-conditioning outlets, filter components and similar parts. The vacuuming inlet and the blowing outlet may share the same interface or may be separately provided with dedicated suction heads or blowing nozzles through quick-release connectors.

The inflation assembly 50 may include a miniature piston or diaphragm air pump, a pressure sensor, a pressure relief valve, and an inflation hose. The air pump is controlled to start and stop by the main control board 20 and monitors the internal air pressure of a tire or other inflation object in real time through the pressure sensor. When a preset value is reached, the air pump automatically stops so as to prevent over-inflation. A universal inflation nozzle is provided at the end of the inflation hose, which is compatible with various inflation scenarios such as automobile tires, bicycles, balls, and the like.

In other words, by integrating the power supply 30, the blowing and vacuuming assembly 40, and the inflation assembly 50 into the same housing 10, and uniformly coordinating and controlling them through the main control board 20, structured and systematic integration of multiple high-frequency vehicle-mounted emergency and maintenance functions is achieved, thereby improving the practicability, portability, and user experience of the multifunctional vehicle-mounted device. Specifically, the power supply 30 not only can supply emergency starting power to a vehicle battery, but also can serve as a common power source to supply power to the blowing and vacuuming assembly 40 and the inflation assembly 50, thereby avoiding space waste and energy redundancy caused by independent batteries provided for traditional separate devices. The blowing and vacuuming assembly 40 realizes rapid switching between the blowing and vacuuming functions through motor forward and reverse rotation or an airflow direction switching mechanism, thereby effectively satisfying diversified scenario requirements such as dust removal in vehicle interior gaps, filter component cleaning, and floor mat cleaning. The inflation assembly 50 is dedicated to rapid air replenishment for vehicle tires or other inflatable articles so as to ensure driving safety. Under the intelligent scheduling of the main control board 20, the three major functional assemblies can operate independently or cooperatively and share some core components, such as the power supply system, motor drive circuit, heat dissipation structure, and the like, thereby greatly simplifying the overall structure, reducing manufacturing costs, and lowering maintenance difficulty.

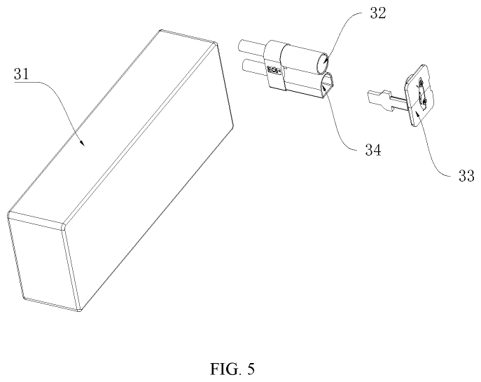

Referring to FIG. 5, in one embodiment, the power supply 30 includes a high-rate battery pack 31, a charging interface 34, and an electric connector-5 (EC5) discharge interface 32. The high-rate battery pack 31, the charging interface 34, and the EC5 discharge interface 32 are each electrically connected to the main control board 20. The high-rate battery pack 31 is mounted inside the housing 10, the charging interface 34 and the EC5 discharge interface 32 are arranged at a side portion of the housing 10 and exposed outwardly from the housing 10.

Specifically, the core of the power supply 30 is a set of high-rate lithium polymer battery packs. For example, the power supply 30 is formed by series-parallel connection of multiple 18650 cells or pouch lithium cells, with a nominal voltage of 12 V and a preferred capacity between 15,000 mAh and 25,000 mAh). Please note, 18650 cell is a lithium-ion battery model (not a circuit component). The high-rate lithium polymer battery packs have high discharge rate characteristics (for example, supporting continuous discharge of 10 C or above) and is capable of instantaneously outputting a large current of hundreds of amperes so as to satisfy the peak power demand of an automobile starter motor. The high-rate battery pack 31 is firmly mounted in a dedicated battery compartment inside the housing 10. The battery compartment is provided with insulating pads, anti-vibration brackets, and thermal management structures, such as thermally conductive silicone pads or heat-dissipating aluminum plates, so as to ensure the safety and stability of the battery under high-load operating conditions.

The charging interface 34 is arranged on an outer surface of one side of the housing 10 and generally adopts a standard Type-C interface or a DC round-hole interface, supporting a wide input voltage range (such as 5 V-24 V) and being compatible with various external power sources, such as a vehicle cigarette lighter, a household adapter, or a fast-charging mobile power supply for recharging. The charging interface 34 is electrically connected to the power management unit (PMU) on the main control board 20 through a cable. A main control chip controls charging current, voltage, and charging state, such as constant-current and constant-voltage phase switching, automatic power-off when fully charged, temperature protection, and the like, so as to realize safe and efficient charging of the high-rate battery pack 31.

The EC5 discharge interface 32 is likewise arranged at the side portion of the housing 10 and exposed outside the housing 10, facilitating quick plug-in and unplugging of a starting cable by a user. EC5 is a high-current power connector widely used in the fields of model aircraft, electric tools, and automobile emergency equipment; its rated current can reach 60 A or above, with low contact resistance, long plug-in and unplugging life, and a reliable latch structure. The EC5 discharge interface 32 is directly electrically connected to a high-power output circuit of the main control board 20, the main control board 20 then controls a metal-oxide-semiconductor field-effect transistor (MOSFET) switch array according to a starting instruction so that electric energy of the high-rate battery pack 31 is output through the EC5 interface to a matched starting clamp cable and is further connected to the positive and negative poles of the vehicle battery, thereby completing the emergency starting operation. During the starting process, the main control board 20 can also monitor output current, voltage, and battery temperature in real time. Once an abnormality is detected, the output is immediately cut off to protect the multifunctional vehicle-mounted device and the vehicle. The abnormality includes short circuit, reverse connection, or overheating, and the like.

In addition, the main control board 20 serves as the control center of the power supply 30. It not only coordinates the charging and discharging paths but is also responsible for sharing battery energy with other functional assemblies of the multifunctional vehicle-mounted device (such as the inflation assembly 50 and the blowing and vacuuming assembly 40) and dynamically allocating power so as to prevent battery overload caused by simultaneous high-load operation of multiple modules.

As shown in FIG. 5, in one embodiment, both the charging interface 34 and the EC5 discharge interface 32 are each provided with a dust-proof silicone plug 33.

Specifically, in order to improve the protection performance of the multifunctional vehicle-mounted device in a complex vehicle-mounted environment, the charging interface 34 and the discharge interface 32 are each provided with an independent dust-proof silicone plug 33. The dust-proof silicone plugs 33 are formed by molding food-grade or industrial-grade silicone rubber material and have good elasticity, high- and low-temperature resistance (generally capable of withstanding −40° C. to +120° C.), aging resistance, and sealing performance. One end of the dust-proof silicone plug 33 is permanently connected to the side wall of the housing 10 through a flexible connecting rib, a thin rope, or a hinge structure so that, when a user pulls out the dust-proof silicone plug 33 to use the interface, the plug body of the dust-proof silicone plug 33 will not fall off or get lost and can be easily reset after use is completed.

In a non-use state, the dust-proof silicone plugs 33 tightly cover and each is embedded inside the corresponding charging interface 34 and discharge interface 32 or completely seals the corresponding interface opening, thereby effectively isolating external dust, water vapor, oil stains, metal debris, and other contaminants from entering the internal contacts of the interface. Even if the vehicle is parked for a long time in a dusty environment, a humid garage, or experiences rain or snow, the interior of the interface can still remain clean and dry.

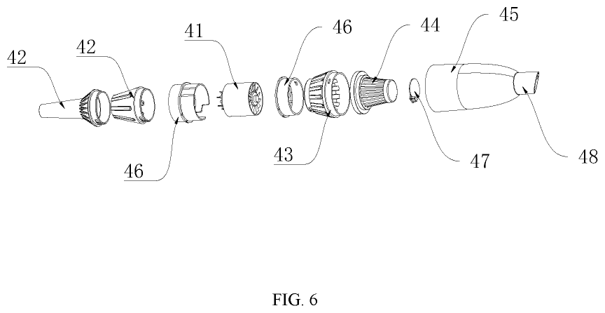

As shown in FIG. 6, in one embodiment, the blowing and vacuuming assembly 40 includes a high-speed motor 41, an air outlet adapter 42, a vacuuming adapter 43, a filter component 44, and a garbage storage chamber 45. The high-speed motor 41 is mounted inside the housing 10 by means of a motor connecting piece 46. The air outlet adapter 42 and the vacuuming adapter 43 are respectively arranged on two sides of the housing 10 and are in fluid communication with the air-duct ends of the high-speed motor 41. The garbage storage chamber 45 is connected to the end of the vacuuming adapter 43 away from the housing 10. The filter component 44 is located between the vacuuming adapter 43 and the garbage storage chamber 45.

Specifically, the blowing and vacuuming assembly 40 employs a high-speed brushless DC motor as the core power source. The rated rotational speed of the motor is generally above 20,000 rpm, and the high-speed brushless DC motor possesses the characteristics of high-efficiency, low noise, long service life, and controllable forward and reverse rotation. The high-speed brushless DC motor is firmly mounted in a vacuuming assembly compartment 004 inside the housing 10 through a dedicated motor connecting piece 46 (such as a metal bracket, a shock-absorbing rubber pad, or an injection-molded snap-fit structure), thereby ensuring good coaxiality during high-speed operation, effectively suppressing vibration transmission to the entire device housing, and preventing structural loosening caused by resonance or discomfort during user gripping.

One end of the high-speed motor 41 is provided with an open-type air-duct outlet. The air-duct outlet communicates, through an internal airflow passage, with the air outlet adapter 42 and the vacuuming adapter 43 located on the two sides of the housing 10, respectively. In terms of structural design, the two adapters are not simultaneously connected. Instead, a mechanical switching mechanism (such as a sliding baffle, a rotary valve, or a quick-disconnect interface) is adopted to realize selection of the functional mode. When the user selects the blowing mode, the airflow path is directed to the air outlet adapter 42. When the vacuuming mode is selected, the airflow path is switched to the side of the vacuuming adapter 43.

The air outlet adapter 42 is a detachable or fixed air-guiding duct. The cross-section of its outlet can be designed, according to usage requirements, as a flat-slit shape, a circular shape, or a multi-hole diffusion shape so as to adjust the airflow velocity and coverage range. For example, a flat-slit air outlet is suitable for concentrated blowing in narrow areas such as keyboard gaps and air-conditioning vents. A diffusion-type air outlet is suitable for dust removal over large-area surfaces. In some embodiments, the air outlet adapter 42 may further be equipped with a flexible extension tube or an elbow joint to enhance operational flexibility.

The vacuuming adapter 43 is a rigid or semi-flexible suction duct. One end thereof is hermetically connected to the negative-pressure-side air-duct of the high-speed motor 41, while the other end extends outward and connects to the garbage storage chamber 45. In general, the garbage storage chamber 45 is a transparent or translucent detachable dust collection box. The filter component 44 is arranged between the vacuuming adapter 43 and the garbage storage chamber 45. The filter component 44 may adopt a multi-layer composite structure, including a primary-efficiency filter screen for intercepting large particles such as hair and debris, a high-efficiency particulate air (HEPA) filter core for capturing micron-level dust, and an activated carbon layer for adsorbing odors, thereby ensuring that the exhausted gas is clean and preventing secondary pollution.

In the vacuuming working state, the high-speed motor 41 rotates in reverse, or cooperates with a unidirectional impeller and a negative-pressure chamber design, to generate negative-pressure airflow inside the vacuuming adapter 43. External dust-laden air enters the garbage storage chamber 45 through the suction nozzle 48. Larger particles are collected at the bottom of the garbage storage chamber 45 by inertial sedimentation, while fine dust is intercepted by the filter component 44. The purified air is finally discharged out of the housing 10 through the motor interior or a bypass passage.

The garbage storage chamber 45 is connected to the vacuuming adapter 43 by means of a snap-fit, a screw buckle, or a magnetic attraction manner, which facilitates quick disassembly, garbage dumping, and filter screen cleaning by the user. In some preferred embodiments, the garbage storage chamber 45 is provided with a visible window, allowing the user to conveniently observe the degree of dust accumulation and perform timely maintenance.

As shown in FIG. 6, In one embodiment, the end of the garbage storage chamber 45 away from the housing 10 is integrally formed with a suction nozzle 48, and the suction nozzle 48 is provided with a leak-proof silicone plug 47.

Specifically, the farthest end of the garbage storage chamber 45 is integrally formed with a suction nozzle 48. The suction nozzle 48 is a rigid or flexible tubular structure. The front-end opening is used to closely approach the surface to be cleaned so as to suck in dust, debris, hair, and other foreign matter. The inner cavity thereof directly communicates with the interior of the garbage storage chamber 45, thereby forming a complete vacuuming airflow passage.

At the opening of the suction nozzle or on the inner side immediately adjacent to the opening, a leak-proof silicone plug 47 is provided. The silicone plug is made of a soft, highly elastic silicone rubber material. It is shaped to precisely match the inner diameter or end face of the suction nozzle, typically in the form of a circular disk, a mushroom-head shape, or a valve structure with a central through-hole. In the non-use state, the leak-proof silicone plug 47 naturally closes, completely covering the opening or being embedded into the suction nozzle opening. When the multifunctional vehicle-mounted device is started and enters the vacuuming mode, the negative-pressure airflow generated by the high-speed motor 41 automatically sucks open the silicone plug (or the plug is manually pushed open by the user), allowing unobstructed airflow entry. After the vacuuming operation is completed, the negative-pressure airflow disappears, and the silicone plug rapidly rebounds and resets by virtue of its own elasticity, thereby re-closing the suction nozzle opening. In some preferred embodiments, the leak-proof silicone plug 47 is connected to the suction nozzle body through a micro-hinge, a thin string, or an integrally formed flexible connecting rib, ensuring that it will not detach or be lost during repeated opening and closing. In addition, the surface of the silicone plug may be designed with micro-textures or edge flanges to enhance the sealing fit and prevent fine particles from escaping through gaps.

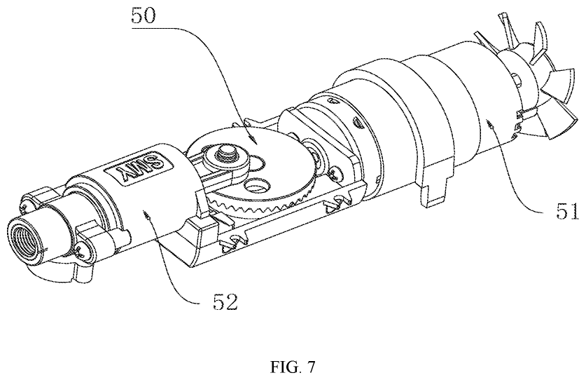

As shown in FIG. 7, in one embodiment, the inflation assembly 50 includes an inflation pump motor 51 and an inflation pipeline 52. The inflation pump motor 51 is installed inside the housing 10. One end of the inflation pipeline 52 communicates with the inflation pump motor 51, and the other end extends out of the housing 10.

Specifically, the inflation pump motor 51 is a high-efficiency, high-temperature-resistant micro-piston-type or diaphragm-type air pump motor capable of continuous long-term operation, preferably with a rated power between 80 W and 150 W. The operating voltage is supplied by the power supply 30. The inflation pump motor 51 is firmly fixed in the inflation assembly chamber 005 inside the housing 10 by means of a metal bracket, a shock-absorbing rubber pad, or an injection-molded snap-fit structure, so as to ensure stability during high-frequency reciprocating motion or high-speed operation, effectively suppress vibration transmission to the entire device, and avoid noise increase or connection failure caused by loosening. The body of the inflation pump motor 51 is integrated with heat-dissipating fins or forms a heat-dissipating air-duct with the inner wall of the housing 10, thereby improving heat-dissipation efficiency and preventing over-temperature protection shutdown.

The inflation pipeline 52 is a section of flexible or semi-rigid pressure-resistant hose, typically made of a multi-layer composite material (such as an inner thermoplastic polyurethane (TPU) layer, an intermediate braided fiber layer, and an outer wear-resistant polyvinyl chloride (PVC) layer), possessing good pressure resistance, flexibility, aging resistance, and capable of withstanding ≥150 PSI (pounds per square inch). One end of the inflation pipeline 52 is tightly connected to the air outlet of the inflation pump motor 51 through a sealed joint, such as a quick-plug air nozzle or a threaded interface, ensuring leak-free transmission of high-pressure gas. The other end passes through a reserved hole on the side wall of the housing 10 and fully extends out of the housing 10, with the terminal end equipped with a standard inflation nozzle, such as a US-standard Schrader nozzle, which can be directly connected to the valve core of an automobile tire or adapted, through an adapter, to different inflation objects such as bicycles, balls, and inflatable mattresses.

In some preferred embodiments, the inflation pipeline 52 is provided with a storage slot or a winding hook at the position corresponding to the exposed end of the inflation pipeline 52, facilitating the user to neatly wind and fix the hose on the surface of the housing 10 when not in use, thereby avoiding scattered dragging. In addition, a rubber sealing ring or an elastic retaining ring may be arranged at the position on the housing 10 corresponding to the outlet of the inflation pipeline 52, which not only ensures the stability of the pipeline when it passes through but also prevents dust or moisture from intruding into the interior of the housing 10 along the gap.

The operation of the inflation pump motor 51 is managed by the main control board 20. After the user activates the inflation function through an operation panel, the main control board 20 drives the inflation pump motor 51 to operate. At the same time, a pressure sensor, which may be integrated in the inflation pipeline 52 or at the motor outlet, may be employed to monitor the inflation pressure in real time. The motor is automatically stopped when the preset value is reached, thereby realizing precise and safe intelligent inflation.

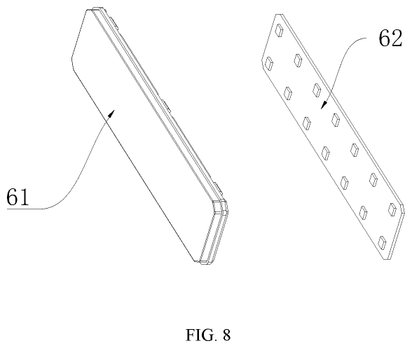

As shown in FIG. 8, in one embodiment, the multifunctional vehicle-mounted device further includes a lighting assembly 60. The lighting assembly 60 includes a light cover 61 and a light-emitting diode (LED) light panel 62. The LED light panel 62 is electrically connected to the main control board 20. The light cover 61 is located on the outer side of the LED light panel 62 and is connected to the housing 10.

Specifically, the lighting assembly 60 serves as an auxiliary functional unit of the multifunctional vehicle-mounted device and is mainly used to provide local illumination in nighttime, underground parking garages, emergency repair, or low-light environments. The module is composed of the LED light panel 62 and the light cover 61, and is integrated in a specific area of the housing 10 (typically the front-end face, side face, or a flippable bracket).

The LED light panel 62 adopts a high-brightness, low-power-consumption surface mounted device (SMD) LED array (such as SMD 2835 or 5050 models) and can be configured, according to requirements, with single-color white light (color temperature approximately 5000 K-6500 K, providing clear illumination) or dual-color/tri-color light sources (such as white light+red light, taking into account both illumination and warning functions). The LED light panel 62 is electrically connected to the main control board 20 through a flexible flat cable or welded wires, and is uniformly powered and controlled by the main control chip. Lighting modes may be switched by a user through a dedicated button, knob, or multi-level short-press operation on the housing 10. The lighting modes includes constant on, burst flash, SOS distress signal, etc. The main control board 20 adjusts the LED driving current according to the instruction to realize brightness adjustment or flicker logic control. At the same time, the main control system can implement over-current, over-temperature, and short-circuit protection for the LED light panel 62, ensuring safety during long-term use.

The light cover 61 is disposed on the outer side of the LED light panel 62 (i.e., the side facing the usage environment) and is typically formed by injection molding from a polycarbonate (PC) or acrylic resin (polymethyl methacrylate, PMMA) material exhibiting high light transmittance and strong impact resistance. The inner surface of the light cover 61 may be provided with a micro-prism structure, diffusion dots, or Fresnel patterns for homogenizing light output and preventing the occurrence of glaring bright spots or dark zones. The outer surface may be designed as a flat surface, a curved surface, or a reflective inclined surface having a certain elevation angle so as to optimize the illumination angle and coverage range. The light cover 61 is securely connected to the front-end opening of the housing 10 by means of snap-fit connections, ultrasonic welding, screws, or sealing rubber rings, thereby ensuring optical performance while providing excellent dust-proof and waterproof capabilities, capable of achieving an IP54 or higher protection rating.

In certain preferred embodiments, a silicone sealing ring is disposed between the light cover 61 and the housing 10 to enhance the reliability of the complete machine in humid, rainy, or foggy environments. In other embodiments, the lighting assembly 60 is integrated onto a rotatable or foldable bracket, thereby enabling a user to adjust the illumination direction according to actual requirements, for example, directing the light toward a work area during engine compartment inspection and maintenance.

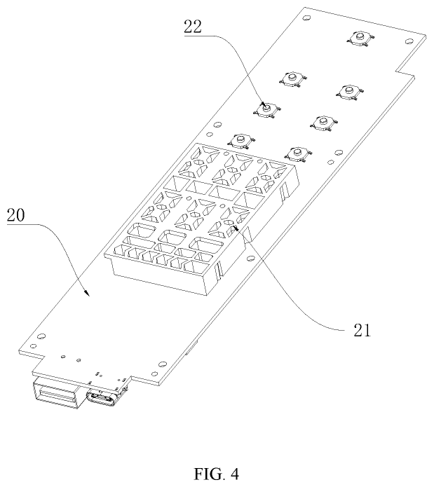

As shown in FIG. 4, in one embodiment, the main control board 20 is further integrated with a digital display 21.

Specifically, the digital display 21 is either directly integrated onto the main control board 20 or electrically connected thereto via a flexible flat cable and is embedded on the front face of the housing 10 or on a side surface that is convenient for user observation. The digital display 21 receives real-time data signals through a drive circuit provided on the main control board 20 and dynamically displays key information related to the operating status of the multifunctional vehicle-mounted device, including but not limited to, the following: the remaining power level of the power supply 30 (presented in the form of a percentage or a battery icon); the tire pressure value currently detected by the inflation assembly 50; the operating status of the blowing or vacuuming mode, such as “blowing in progress,” “vacuuming in progress,” or wind-speed gear; the on/off status or flashing mode of the lighting assembly 60; fault prompt information, such as “overheat protection,” “reverse-connection alarm,” “filter clogging,” etc.; and charging status, such as “charging in progress” or “fully charged”.

In addition, in certain other embodiments, the digital display 21 supports touch-control operation or is linked with physical keys, allowing the user to switch between different information pages by means of short presses, long presses, or key combinations, thereby achieving more refined state monitoring and parameter setting, for example, presetting a target tire pressure value.

In one embodiment, a surface sticker 11 is further provided on the outer side of the housing 10 in the region corresponding to the digital display 21.

Specifically, the face sticker 11 is a transparent or translucent film patch made of polyethylene terephthalate (PET) material, preferably having a thickness between 0.1 mm and 0.3 mm, and possessing high light transmittance (≥90%), excellent wear resistance, scratch resistance, chemical corrosion resistance, as well as good flexibility and dimensional stability. The face sticker is precisely cut into a shape corresponding to the digital display window region on the housing 10, such as a rectangle, a circle, or a polygon, and is firmly adhered to the outer side of the housing 10, on the surface directly facing the digital display, by means of a back adhesive, such as an acrylic pressure-sensitive adhesive.

As shown in FIG. 4, in a specific embodiment, the main control board 20 is further integrated with an indicator light 22.

Specifically, the indicator light 22 is directly soldered or surface-mounted onto the main control board 20 and is visible from the exterior through light-transmitting holes or light-guide columns reserved on the surface of the housing 10. The indicator light 22 typically employs a high-brightness, low-power-consumption surface-mount LED, for example, in a 0603 or 0805 package, and may be configured as a single-color LED (such as red, green, or blue) or a multi-color LED, such as a two-color RGB or red-green dual-core LED, according to functional requirements.

In terms of circuit connection, the positive and negative electrodes of the indicator light 22 are electrically connected to the microcontroller (MCU) input/output pins on the main control board 20 through current-limiting resistors. The MCU outputs high-level or low-level signals according to the current operating state of the multifunctional vehicle-mounted device so as to control the illumination, shutdown, flashing frequency, or color switching of the indicator light 22. The indicator light 22 includes the following application scenarios.

Power/electric-quantity status: a steady green light indicates sufficient battery power, a slow-flashing red light indicates that the battery power is below 20%, and a fast-flashing red light indicates that the battery power is extremely low and requires charging.

Function-mode prompt: a steady blue light indicates the blowing mode, a steady purple light indicates the vacuuming mode, and a steady yellow light indicates that the inflation assembly 50 is operating.

Fault or protection status: a steady red light indicates activation of reverse-connection protection, and a rapidly flashing red light indicates motor overheating or stalling.

Charging status: a steady orange light indicates that charging is in progress, and a steady green light indicates that charging is complete.

The foregoing embodiments represent preferred implementations of the present disclosure. In addition, the present disclosure may be implemented in other manners, and any obvious substitutions that do not depart from the inventive concept of the technical solution fall within the protection scope of the present disclosure.

What is claimed is:

1. A multifunctional vehicle-mounted device, comprising: a housing mounted with a main control board, a power supply, a blowing and vacuuming assembly and an inflation assembly;
wherein the power supply, the blowing and vacuuming assembly and the inflation assembly are each electrically connected to the main control board; and
wherein the power supply is configured to start in an emergency state and supply power to the blowing and vacuuming assembly and the inflation assembly, the blowing and vacuuming assembly is configured to generate positive-pressure airflow and negative-pressure airflow, and the inflation assembly is configured to inflate vehicle tires.

2. The multifunctional vehicle-mounted device of claim 1, wherein the power supply comprises a battery pack, a charging interface and a discharge interface;
wherein the battery pack, the charging interface and the discharge interface are each electrically connected to the main control board; and
wherein the battery pack is installed inside the housing; and
wherein the charging interface and the discharge interface are disposed on a side portion of the housing and exposed outwardly.

3. The multifunctional vehicle-mounted device of claim 2, wherein the charging interface and the discharge interface are each provided with a dust-proof silicone plug.

4. The multifunctional vehicle-mounted device of claim 1, wherein the blowing and vacuuming assembly comprises a motor, an air outlet adapter, a vacuuming adapter, a filter component and a garbage storage chamber;
wherein the motor is mounted inside the housing by a motor connecting piece, the air outlet adapter and the vacuuming adapter are respectively disposed on opposite sides of the housing and are in fluid communication with air-duct ends of the motor; and
wherein the garbage storage chamber is connected to one end of the vacuuming adapter away from the housing, and the filter component is located between the vacuuming adapter and the garbage storage chamber.

5. The multifunctional vehicle-mounted device of claim 4, wherein an end of the garbage storage chamber away from the housing is provided with a suction nozzle, and the suction nozzle is provided with a leak-proof silicone plug.

6. The multifunctional vehicle-mounted device of claim 1, wherein the inflation assembly comprises an inflation pump motor and an inflation pipeline, the inflation pump motor is mounted inside the housing, one end of the inflation pipeline communicates with the inflation pump motor, and the other end extends out of the housing.

7. The multifunctional vehicle-mounted device of claim 1, wherein the multifunctional vehicle-mounted device further comprises a lighting assembly;
wherein the lighting assembly comprises a light cover and a light-emitting diode (LED) light panel electrically connected to the main control board; and
wherein the light cover is located on an outer side of the LED light panel and connected to the housing.

8. The multifunctional vehicle-mounted device of claim 1, wherein the main control board is further integrated with a digital display.

9. The multifunctional vehicle-mounted device of claim 8, wherein the housing further comprises a surface sticker disposed on an outer side of the housing in a region corresponding to the digital display.

10. The multifunctional vehicle-mounted device of claim 1, wherein the main control board is further integrated with an indicator light.
